(19) United States
(12) Patent Application Publication
(10) Pub. No.: US 2022/0319414 A1
(43) Pub. Date: Oct. 6, 2022

(54) PIXEL DRIVING CIRCUIT, DISPLAY PANEL, AND DRIVING METHOD THEREOF

(71) Applicant: WUHAN CHINA STAR OPTOELECTRONICS SEMICONDUCTOR DISPLAY TECHNOLOGY CO., LTD., Wuhan, Hubei (CN)

(72) Inventors: Zengjian JIN, Wuhan, Hubei (CN); Qibing DAI, Wuhan, Hubei (CN); Fuchih CHANG, Wuhan, Hubei (CN); Wu ZHENG, Wuhan, Hubei (CN)

(21) Appl. No.: 17/262,091

(22) PCT Filed: Aug. 26, 2020
(86) PCT No.: PCT/CN2020/111300

§ 371 Date: Jan. 21, 2021

(30) Foreign Application Priority Data
Aug. 7, 2020 (CN) 202010786811.4

(51) Int. Cl. G09G 3/3233

(52) U.S. Cl. CPC G09G 3/3233; G09G 2300/0842; G09G 2300/043; G09G 2340/0435; G09G 2300/0861; G09G 2320/0233

(57) ABSTRACT

A pixel driving circuit, a display panel, and a driving method thereof are provided. The pixel driving circuit includes a first transistor T1, a second transistor T2, a storage capacitor Cst, a low frame rate compensation capacitor unit, and an organic light-emitting device OLED.

### FIELD OF INVENTION

The present application relates to the field of display technologies, and in particular to a pixel driving circuit, a display panel, and a driving method thereof.

### BACKGROUND OF INVENTION

With multiple organic light-emitting diode production lines completed and put into production, as well as an increase in yield, a proportion of organic light-emitting diode display panels used in mobile phones has greatly increased. At the same time, due to its excellent display characteristics, it is also used in smart wear and other products.

However, in order to provide users with a better experience in smart wear and other products, more application scenarios will be set up. For example, mobile phones and watches need to be driven by high frame rate or low frame rate to adapt to different application scenarios. A storage capacitance required for high frame rate driving is small, and a storage capacitance required for low frame rate driving is greater.

As shown in FIG. 1, it is an existing pixel driving circuit for an organic light-emitting diode display panel, in which a storage capacitor Cst has a small storage capacitance and is a storage capacitor with a fixed capacitance, which cannot simultaneously take into consideration both high frame rate and low frame rate driving.

### SUMMARY OF INVENTION

### Technical Problem

An object of the present invention is to provide a pixel driving circuit, a display panel, and a driving method thereof to solve technical problems that light-emitting brightness of a light-emitting diode is rapidly reduced when a threshold voltage is a negative voltage in conventional art, a current of the light-emitting diode is rapidly reduced, and a data signal suffers serious loss.

### Technical Solutions

In order to achieve the above objective, the present invention provides a pixel driving circuit, including a first transistor T1, a second transistor T2, a storage capacitor Cst, a low frame rate compensation capacitor unit, and an organic light-emitting device OLED. Specifically, a gate of the first transistor T1 is connected to a first node G, a source of the first transistor T1 is connected to a second node N, the second node is connected to a power supply voltage VDD, and a drain of the first transistor T1 is connected to a third node S. A gate of the second transistor T2 is connected to a first scan signal Scan[n], and a source of the second transistor T2 is connected to a data signal Data, and a drain of the second transistor T2 is connected to the second node N. An end of the storage capacitor Cst is connected to the power supply voltage VDD, and the other end of the storage capacitor is connected to the first node G. The low frame rate compensation capacitor unit is connected to the storage capacitor Cst in parallel, an end of the low frame rate compensation capacitor unit is connected to the power supply voltage VDD, and the other end of the low frame rate compensation capacitor unit is connected to the first node G. An anode of the organic light-emitting device OLED is connected to the third node S, and a cathode of the organic light-emitting device is connected to a negative voltage VSS.

Furthermore, the low frame rate compensation capacitor unit includes a compensation capacitor Cb and a low frame rate turn-on transistor Tb connected in series.

Furthermore, the low frame rate turn-on transistor Tb is an N-type or P-type transistor, a material of an active layer in the low frame rate turn-on transistor Tb includes amorphous silicon material or metal oxide material, and the metal oxide material includes indium gallium zinc oxide (IGZO), indium zinc tin oxide (IZTO), or indium gallium zinc tin oxide (IGZTO).

Furthermore, a gate of the low frame rate turn-on transistor Tb is connected to a control signal Cb_EN, a source of the low frame rate turn-on transistor Tb is connected to the power supply voltage VDD, a drain of the low frame rate turn-on transistor Tb is connected to the first node G, when the pixel driving circuit is in a low frame rate mode, the control signal Cb_EN controls the low frame rate turn-on transistor Tb to turn on, and when the pixel driving circuit is in a high frame rate mode, the control signal Cb_EN controls the low frame rate turn-on transistor Tb to turn off.

Furthermore, the pixel driving circuit further includes a third transistor T3, wherein a gate of the third transistor T3 is connected to a light-emitting signal EM[n], a source of the third transistor T3 is connected to the power supply voltage, and a drain of the third transistor T3 is connected to the second node N.

Furthermore, the pixel driving circuit further includes a fourth transistor T4, wherein a gate of the fourth transistor T4 is connected to the first scan signal Scan[n], a source of the fourth transistor T4 is connected to the first node G, and a drain of the fourth transistor T4 is connected to the third node S.

Furthermore, the pixel driving circuit further includes a fifth transistor T5, wherein a gate of the fifth transistor T5 is connected to a second scan signal Scan[n−1], a source of the fifth transistor T5 is connected to the first node G, and a drain of the fifth transistor T5 is connected to a reset voltage VI.

Furthermore, the pixel driving circuit further includes a sixth transistor T6, wherein a gate of the sixth transistor T6 is connected to a light-emitting signal EM[n], a source of the sixth transistor T6 is connected to the third node S, and a drain of the sixth transistor T6 is connected to the anode of the organic light-emitting device OLED.

The present invention further provides a display panel, wherein the display panel includes the driving circuit as above described.

The present invention further provides a driving method of the display panel as above described, including following steps:

a display panel application switching step, configured to light up a screen or switch to a display screen of an application software;

an application frame rate detecting step, configured to detect a frame rate of a current application software of the display panel;

an application frame rate judging step, wherein when a driving system detects that a display terminal application software needs to be driven by a low frame rate (less than or equal to 60 Hz), a system terminal will switch to a low frame rate mode and output a switching signal to the display panel, and when the driving system detects that the display terminal application software needs to be driven by a high frame rate (greater than 60 Hz), the system terminal will switch to a high frame rate mode and output the switching signal to the display panel; and

a low frame rate turn-on transistor controlling step, wherein in the low frame rate mode, a control signal Cb_EN controls a low frame rate turn-on transistor Tb to turn on, a compensation capacitor Cb and a storage capacitor Cst are used in parallel, and in the high frame rate mode, the control signal Cb_EN controls the low frame rate turn-on transistor Tb to turn off, and the storage capacitor Cst is used alone.

### Beneficial Effect

The technical effect of the present invention is to provide a pixel driving circuit, a display panel, and a driving method thereof. By adding a low frame rate compensation capacitor unit, a capacitor structure in the pixel driving circuit is optimized. A capacitor with same function is divided into two parts to simultaneously take into consideration a high frame rate mode or a low frame rate mode. It can ensure stability of a voltage at a lower refresh rate, and at the same time, ensures that a total capacitance value is increased when a high frame rate is driven, and a voltage is accurately written in a short time.

### BRIEF DESCRIPTION OF FIGURES

FIG. 1 is a pixel driving circuit of a conventional organic light-emitting diode display panel.

FIG. 2 is a schematic structural diagram of a pixel driving circuit according to a first embodiment of the present invention.

FIG. 3 is a charging principle diagram of the pixel driving circuit.

FIG. 4 is a schematic principle diagram of a voltage holding of the pixel driving circuit.

FIG. 5 is a schematic structural diagram of a pixel driving circuit according to a second embodiment of the present invention.

FIG. 6 is a schematic structural diagram of a pixel driving circuit according to a third embodiment of the present invention.

FIG. 7 is a flowchart of a driving method of a display panel according to the third embodiment of the present invention.

FIG. 8 is a flowchart of the display panel adopting the driving method shown in FIG. 7 according to an embodiment of the present invention.

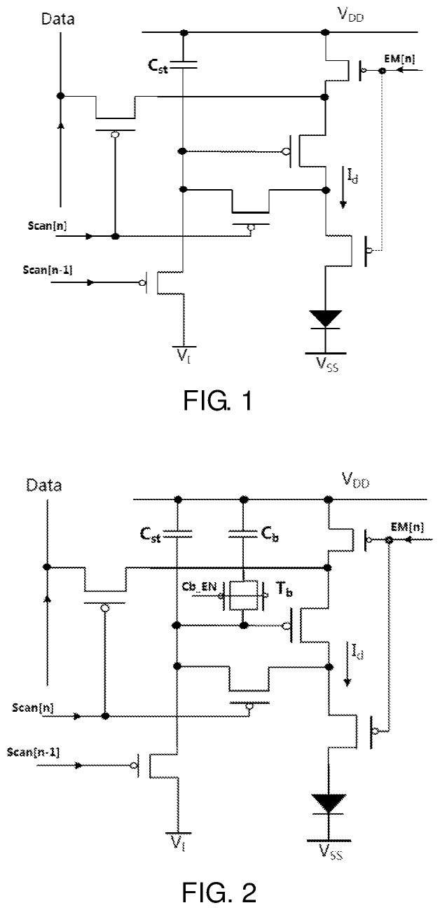

Wherein, references in drawings are as follows:

T1, first transistor; T2, second transistor; T3, third transistor;

T4, fourth transistor; T5, fifth transistor; T6, sixth transistor;

Cst, storage capacitor; Cb, compensation capacitor; Tb, low frame rate turn-on transistor; and

OLED, organic light-emitting device.

### DETAILED DESCRIPTION OF EMBODIMENTS

The following content combines with the drawings and the embodiment for describing the present application in detail. It is obvious that the following embodiments are merely some embodiments of the present application, but not all the embodiments. Based on the embodiments in the present application, for the skilled persons of ordinary skill in the art without creative effort, the other embodiments obtained thereby are still covered by the present application.

In the description of the present invention, it is to be understood that the terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc., the orientation or positional relationship of the indications is based on the orientation or positional relationship shown in the drawings, and is merely for the convenience of the description of the invention and the simplified description, rather than indicating or implying that the device or component referred to has a specific orientation, in a specific orientation. The construction and operation are therefore not to be construed as limiting the invention. In addition, unless otherwise defined, any technical or scientific term used herein shall have the common meaning understood by a person of ordinary skills. Such words as “first” and “second” used in the specification and claims are merely used to differentiate different components rather than to represent any order, number or importance. In the description of the present invention, the meaning of “plurality” is two or more unless specifically defined otherwise.

In the description of the present application, it should be noted that the terms “installation”, “connected”, and “coupled” should be understood in a broad sense, unless explicitly stated and limited otherwise. For example, they may be fixed connections, removable connected or integrally connected; it can be mechanical, electrical, or can communicate with each other; it can be directly connected, or it can be indirectly connected through an intermediate medium, it can be an internal communication of two elements or an interaction relationship of two elements. For those of ordinary skill in the art, the specific meanings of the above terms in the present application can be understood according to specific situations.

### First Embodiment

As shown in FIG. 2, a first embodiment of the present application provides a pixel driving circuit, which includes a first transistor T1, a second transistor T2, a third transistor T3, a fourth transistor T4, a fifth transistor T5, a sixth transistor T6, a storage capacitor Cst, a low frame rate compensation capacitor unit, and an organic light-emitting device OLED. The low frame rate compensation capacitor unit includes a compensation capacitor Cb and a low frame rate turn-on transistor Tb connected in series. The compensation capacitor Cb is positioned above the low frame rate turn-on transistor Tb. Id in the figure indicates a direction of a current.

Wherein, the first transistor T1, the second transistor T2, the third transistor T3, the fourth transistor T4, the fifth transistor T5, the sixth transistor T6, and the low frame rate turn-on transistor Tb are any one of a low-temperature polysilicon thin film transistor, an oxide semiconductor thin film transistor, or an amorphous silicon thin film transistor.

Specifically, in the present embodiment, a gate of the first transistor T1 is connected to a first node G, a source of the first transistor T1 is connected to a second node N, the second node is connected to a power supply voltage VDD, and a drain of the first transistor T1 is connected to a third node S. A gate of the second transistor T2 is connected to a first scan signal Scan[n], and a source of the second transistor T2 is connected to a data signal Data, and a drain of the second transistor T2 is connected to the second node N. An end of the storage capacitor Cst is connected to the power supply voltage VDD, and the other end of the storage capacitor is connected to the first node G. The low frame rate compensation capacitor unit is connected to the storage capacitor Cst in parallel, an end of the low frame rate compensation capacitor unit is connected to the power supply voltage VDD, and the other end of the low frame rate compensation capacitor unit is connected to the first node G. An anode of the organic light-emitting device OLED is connected to the third node S, and a cathode of the organic light-emitting device is connected to a negative voltage VSS.

In the present embodiment, the low frame rate turn-on transistor Tb is an N-type or P-type transistor, the low frame rate turn-on transistor Tb is manufactured by a low temperature polysilicon (LTPS) or low temperature poly oxide (LTPO) process. Material of an active layer in the low frame rate turn-on transistor Tb includes amorphous silicon material or metal oxide material, and the metal oxide material includes indium gallium zinc oxide (IGZO), indium zinc tin oxide (IZTO), or indium gallium zinc tin oxide (IGZTO). When the active layer in the low frame rate turn-on transistor Tb is made with the amorphous silicon material, the low frame rate turn-on transistor Tb is manufactured by the low temperature polysilicon (LTPS) process, and when the active layer in the low frame rate turn-on transistor Tb is made with the metal oxide material, the low frame rate turn-on transistor Tb is manufactured by the low temperature poly oxide (LTPO) process.

In the present embodiment, a gate of the low frame rate turn-on transistor Tb is connected to a control signal Cb_EN, a source of the low frame rate turn-on transistor Tb is connected to the power supply voltage VDD, and a drain of the low frame rate turn-on transistor Tb is connected to the first node G.

When the pixel driving circuit is in a low frame rate mode, the control signal Cb_EN controls the low frame rate turn-on transistor Tb to turn on, and the compensation capacitor Cb and the storage capacitor Cst are used in parallel. When the pixel driving circuit is in a high frame rate mode, the control signal Cb_EN controls the low frame rate turn-on transistor Tb to turn off, and the storage capacitor Cst is used alone.

It is worth noting that in the embodiments of the present application, a demarcation threshold for distinguishing between the low frame rate mode and the high frame rate mode is preferably 60 Hz, but the demarcation threshold is not strictly limited to 60 Hz, and it can also be any integer from 40 to 80 Hz, all of which are belong to the protection scope of the present application. A frame rate in the low frame rate mode ranges from 1 Hz to 60 Hz, and a frame rate in the high frame rate mode ranges from 60 Hz to 120 Hz.

In the present embodiment, by adding the low frame rate compensation capacitor unit, a capacitor structure in the pixel driving circuit is optimized. A capacitor with same function is divided into two parts to simultaneously take into consideration the high frame rate mode or the low frame rate mode. It can ensure stability of a voltage at a lower refresh rate, and at the same time ensure that a total capacitance value is increased when a high frame rate is driven, and a voltage is accurately written in a short time.

In the present embodiment, the pixel driving circuit further includes a third transistor T3, a gate of the third transistor T3 is connected to a light-emitting signal EM[n], a source of the third transistor T3 is connected to the power supply voltage VDD, and a drain of the third transistor T3 is connected to the second node N.

In the present embodiment, the pixel driving circuit further includes a fourth transistor T4, a gate of the fourth transistor T4 is connected to the first scan signal Scan[n], a source of the fourth transistor T4 is connected to the first node G, and a drain of the fourth transistor T4 is connected to the third node S.

In the present embodiment, the pixel driving circuit further includes a fifth transistor T5, a gate of the fifth transistor T5 is connected to the second scan signal Scan[n−1], a source of the fifth transistor T5 is connected to the first node G, and a drain of the fifth transistor T5 is connected to a reset voltage VI. When scanning in a forward direction, it is first reset by the reset voltage VI, and the fifth transistor T5 is turned on.

In the present embodiment, the pixel driving circuit further includes a sixth transistor T6, a gate of the sixth transistor T6 is connected to the light-emitting signal EM[n], a source of the sixth transistor T6 is connected to the third node S, and a drain of the sixth transistor T6 is connected to the anode of the organic light-emitting device OLED.

The pixel driving circuit of the present application has performed simulation data to confirm that a corresponding function can be realized. Different capacitors require different charging time. The smaller the capacitance, the shorter the charging time. Small capacitors can be used at high frame rates, that is, the storage capacitor Cst can be used alone. For low frame rates, the charging time is longer, and a combined large capacitor can be used, that is, the compensation capacitor Cb and the storage capacitor Cst are used in parallel. In addition, a capacitor retention effect is better when the storage capacitor is large, and the combined large capacitor can be configured to enhance a voltage holding when the frame rate is low.

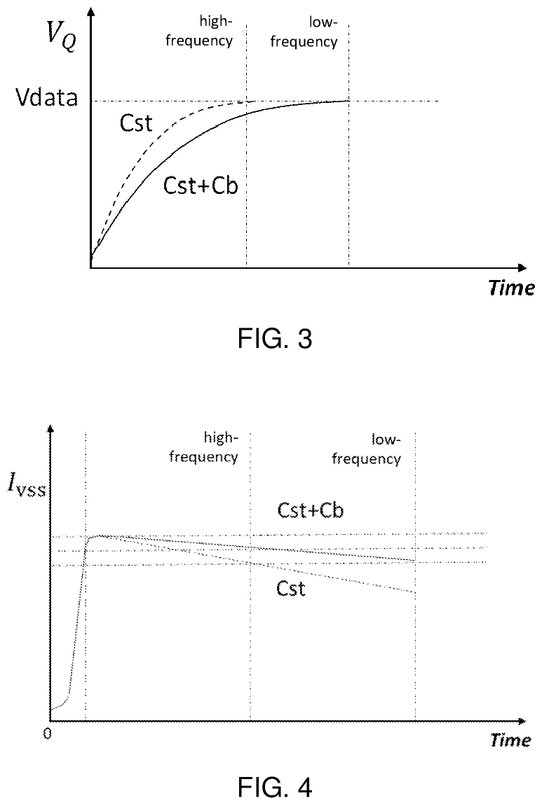

Combined with simulation results, FIG. 3 and FIG. 4 are drawn to explain a principle of the pixel driving circuit.

FIG. 3 is a charging principle diagram of the pixel driving circuit, where a horizontal axis is time, and a vertical axis is a voltage VQ at point Q. A capacitance corresponding to high-frequency driving is Cst, the smaller the capacitance, the faster the voltage rises, and a data voltage Vdata of the data signal Data is reached in a shorter time. A capacitance corresponding to low-frequency driving is Cst+Cb, the larger the capacitance, the slower the voltage rises, and the data voltage Vdata of the data signal Data is reached in a longer time. Therefore, storage capacitors of different sizes can be selected according to different driving frame rates to minimize differences of the voltage VQ at point Q caused by differences in charging time.

FIG. 4 is a schematic principle diagram of a voltage holding of the pixel driving circuit. The horizontal axis is time Time, the vertical axis is a current value IVSS of the negative voltage VSS, the capacitance corresponding to high-frequency driving is Cst, the capacitance is small, and a same leakage current causes a faster voltage change. The capacitance corresponding to low-frequency driving is Cst+Cb, the capacitance is slower, and the same leakage current causes a slower voltage change. The storage capacitors of different sizes are selected according to different driving frame rates, and the differences of the voltage VQ at point Q caused by differences in charging time is reduced as much as possible.

### Second Embodiment

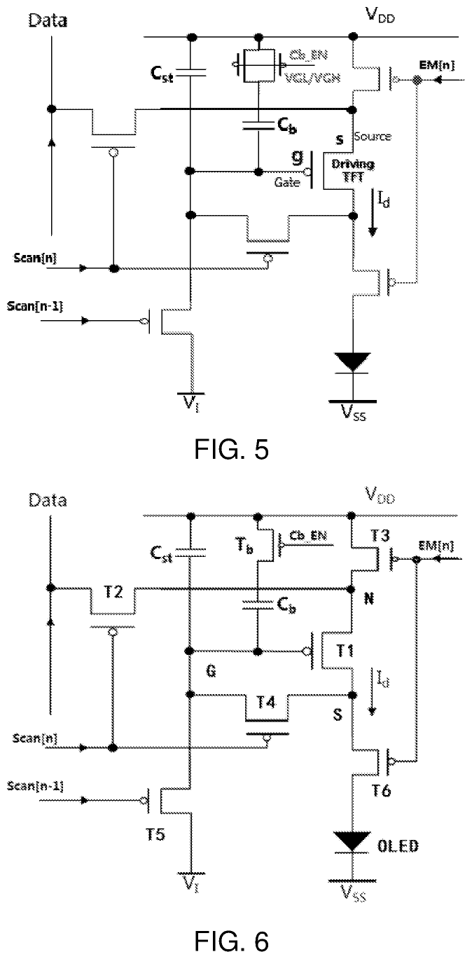

As shown in FIG. 5, a second embodiment includes most of the technical features of the first embodiment, the difference is that the compensation capacitor Cb in the second embodiment is positioned below the low frame rate turn-on transistor Tb, rather than the compensation capacitor Cb in the first embodiment being positioned above the low frame rate turn-on transistor Tb.

In FIG. 5, the compensation capacitor Cb is positioned below the low frame rate turn-on transistor Tb, compared with a configuration of FIG. 2, positions of the compensation capacitor Cb and the low frame rate turn-on transistor Tb are exchanged. Wherein, positioned above and below are the relative position descriptions in the drawings.

### Third Embodiment

As shown in FIG. 6, a third embodiment includes most of the technical features of the second embodiment, the difference is that the low frame rate turn-on transistor Tb in the third embodiment is a single gate structure, rather than the low frame rate turn-on transistor Tb in the second embodiment being a dual-gate structure.

It is also understandable that the low frame rate turn-on transistor Tb with the single gate structure can also replace the low frame rate turn-on transistor Tb with the dual-gate structure in first embodiment.

Based on the same inventive concept, an embodiment of the present invention provides a display panel including any of the above-mentioned driving circuits. A display device in the present embodiment can be any product or component with a display function, such as a mobile phone, a tablet computer, a television, a monitor, a notebook computer, a digital photo frame, a navigator, and the like.

Working principle of the display panel provided in the present embodiment is consistent with the working principle of the above-mentioned driving circuit embodiments. For specific structural relationships and working principles, please refer to the above-mentioned driving circuit embodiments, which will not be repeated here.

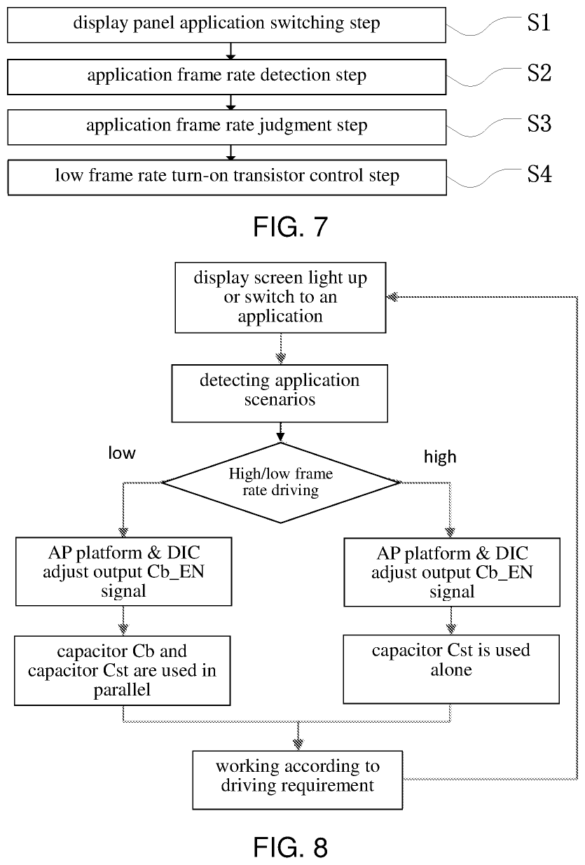

As shown in FIG. 7, the present invention further provides a driving method of the display panel, which includes following steps:

S1, a display panel application switching step, configured to light up a screen or switch to a display screen of an application software;

S2, an application frame rate detecting step, configured to detect a frame rate of a current application software of the display panel;

S3, an application frame rate judging step, wherein when a driving system detects that a display terminal application software needs to be driven by a low frame rate, a system terminal will switch to a low frame rate mode and output a switching signal to the display panel, and when the driving system detects that the display terminal application software needs to be driven by a high frame rate, the system terminal will switch to a high frame rate mode and output the switching signal to the display panel, wherein when a detected frame rate is less than or equal to 60 Hz, it is judged as low frame rate, then it is the low frame rate mode, and when the detected frame rate is greater than 60 Hz, it is judged as high frame rate, and then it is the high frame rate mode; and

S4, a low frame rate turn-on transistor controlling step, wherein in the low frame rate mode, a control signal Cb_EN controls a low frame rate turn-on transistor Tb to turn on, a compensation capacitor Cb and a storage capacitor Cst are used in parallel, and in the high frame rate mode, the control signal Cb_EN controls the low frame rate turn-on transistor Tb to turn off, and the storage capacitor Cst is used alone.

It is worth noting that in the embodiments of the present application, the demarcation threshold for distinguishing between the low frame rate mode and the high frame rate mode is preferably 60 Hz, but the demarcation threshold is not strictly limited to 60 Hz, and it can also be any integer from 40 to 80 Hz, all of which are belong to the protection scope of the present application. The frame rate in the low frame rate mode ranges from 1 Hz to 60 Hz, and the frame rate in the high frame rate mode ranges from 60 Hz to 120 Hz.

As shown in FIG. 8, FIG. 8 is a flowchart of the display panel adopting the driving method shown in FIG. 7, which implements driving corresponding to the driving method of the display panel shown in FIG. 7.

The technical effect of the present invention is to provide the pixel driving circuit, the display panel, and the driving method thereof. By adding the low frame rate compensation capacitor unit, the capacitor structure in the pixel driving circuit is optimized. A capacitor with same function is divided into two parts to simultaneously take into consideration the high frame rate mode or the low frame rate mode. It can ensure stability of a voltage at a lower refresh rate, and at the same time ensure that a total capacitance value is increased when a high frame rate is driven, and a voltage is accurately written in a short time.

In the above-mentioned embodiments, the description of each embodiment has its own focus. For parts that are not described in detail in an embodiment, reference can be made to related descriptions of other embodiments.

A pixel driving circuit, a display panel, and a driving method thereof provided in the embodiments of the present application have been described in detail above. Specific embodiments have been used in this document to explain the principle and implementation of the present application. The descriptions of the above embodiments are only used to help understand the technical solution of the present application and its core ideas. For a person skilled in the art, any modification of equivalent structure or equivalent process made according to the disclosure and drawings of the present invention, or any application thereof, to other related fields of technique, is considered encompassed in the scope of protection defined by the claims of the present invention.

What is claimed is:

1. A pixel driving circuit, comprising:
a first transistor, wherein a gate of the first transistor is connected to a first node, a source of the first transistor is connected to a second node, the second node is connected to a power supply voltage, and a drain of the first transistor is connected to a third node;
a second transistor, wherein a gate of the second transistor is connected to a first scan signal, a source of the second transistor is connected to a data signal, and a drain of the second transistor is connected to the second node;
a storage capacitor, wherein an end of the storage capacitor is connected to the power supply voltage, and the other end of the storage capacitor is connected to the first node;
a low frame rate compensation capacitor unit connected to the storage capacitor in parallel, wherein an end of the low frame rate compensation capacitor unit is connected to the power supply voltage, and the other end of the low frame rate compensation capacitor unit is connected to the first node; and
an organic light-emitting device, wherein an anode of the organic light-emitting device is connected to the third node and a cathode of the organic light-emitting device is connected to a negative voltage.

2. The pixel driving circuit of claim 1, wherein the low frame rate compensation capacitor unit comprises a compensation capacitor and a low frame rate turn-on transistor connected in series.

3. The pixel driving circuit of claim 2, wherein the low frame rate turn-on transistor is an N-type or P-type transistor, a material of an active layer in the low frame rate turn-on transistor comprises amorphous silicon material or metal oxide material, and the metal oxide material comprises indium gallium zinc oxide (IGZO), indium zinc tin oxide (IZTO), or indium gallium zinc tin oxide (IGZTO).

4. The pixel driving circuit of claim 2, wherein a gate of the low frame rate turn-on transistor is connected to a control signal, a source of the low frame rate turn-on transistor is connected to the power supply voltage, a drain of the low frame rate turn-on transistor is connected to the first node, when the pixel driving circuit is in a low frame rate mode, the control signal controls the low frame rate turn-on transistor to turn on, and when the pixel driving circuit is in a high frame rate mode, the control signal controls the low frame rate turn-on transistor to turn off.

5. The pixel driving circuit of claim 1, further comprising a third transistor, wherein a gate of the third transistor is connected to a light-emitting signal, a source of the third transistor is connected to the power supply voltage, and a drain of the third transistor is connected to the second node.

6. The pixel driving circuit of claim 1, further comprising a fourth transistor, wherein a gate of the fourth transistor is connected to the first scan signal, a source of the fourth transistor is connected to the first node, and a drain of the fourth transistor is connected to the third node.

7. The pixel driving circuit of claim 1, further comprising a fifth transistor, wherein a gate of the fifth transistor is connected to a second scan signal, a source of the fifth transistor is connected to the first node, and a drain of the fifth transistor is connected to a reset voltage.

8. The pixel driving circuit of claim 1, further comprising a sixth transistor, wherein a gate of the sixth transistor is connected to a light-emitting signal, a source of the sixth transistor is connected to the third node, and a drain of the sixth transistor is connected to the anode of the organic light-emitting device.

9. A display panel, wherein the display panel comprises the driving circuit of claim 1.

10. A driving method of the display panel as claimed in claim 9, comprising following steps:
a display panel application switching step, configured to light up a screen or switch to a display screen of an application software;
an application frame rate detecting step, configured to detect a frame rate of a current application software of the display panel;
an application frame rate judging step, wherein when a driving system detects that a display terminal application software needs to be driven by a low frame rate, a system terminal will switch to a low frame rate mode and output a switching signal to the display panel, and when the driving system detects that the display terminal application software needs to be driven by a high frame rate, the system terminal will switch to a high frame rate mode and output the switching signal to the display panel; and
a low frame rate turn-on transistor controlling step, wherein in the low frame rate mode, a control signal controls a low frame rate turn-on transistor to turn on, a compensation capacitor and a storage capacitor are used in parallel, and in the high frame rate mode, the control signal controls the low frame rate turn-on transistor to turn off, and the storage capacitor is used alone.
